(19) United States
(12) Patent Application Publication
(10) Pub. No.: US 2025/0012189 A1
(43) Pub. Date: Jan. 9, 2025

(54) ANTI-CORROSION MATERIAL AND ANTI-CORROSION METHOD FOR SUBMERGED FLOATING TUNNEL PIPE SECTION CONCRETE

(71) Applicants: CCCC SHANGHAI THIRD HARBOUR ENGINEERING SCIENCE & TECHNOLOGY RESEARCH INSTITUTE CO., LTD., Shanghai (CN); CCCC THIRD HARBOR ENGINEERING CO., LTD., Shanghai (CN)

(72) Inventors: Chengqi WANG, Shanghai (CN); Zishan FANG, Shanghai (CN); Yuanbo LIANG, Shanghai (CN); Yulin GUO, Shanghai (CN)

(73) Assignees: CCCC SHANGHAI THIRD HARBOUR ENGINEERING SCIENCE & TECHNOLOGY RESEARCH INSTITUTE CO., LTD., Shanghai (CN); CCCC THIRD HARBOR ENGINEERING CO., LTD., Shanghai (CN)

(21) Appl. No.: 18/706,005

(22) PCT Filed: Aug. 29, 2022
(86) PCT No.: PCT/CN2022/115382

§ 371 Date: Apr. 30, 2024

(30) Foreign Application Priority Data
Dec. 21, 2021 (CN) 202111568992.4

(51) Int. Cl. E21D 11/00; B32B 5/02; B32B 7/12; B32B 13/14; B32B 33/00; B32B 37/26; B32B 38/16

(52) U.S. Cl. CPC E21D 11/003; B32B 5/022; B32B 7/12; B32B 13/14; B32B 33/00; B32B 37/26; B32B 38/162; B32B 2255/02; B32B 2255/26; B32B 2262/101; B32B 2307/54; B32B 2307/546; B32B 2307/714; B32B 2307/7265; B32B 2307/73; B32B 2307/7376; B32B 2315/085; B32B 2383/00; B32B 2597/00

(57) ABSTRACT

An anti-corrosion material and anti-corrosion method for submerged floating tunnel pipe section concrete is provided. The anti-corrosion material includes: a base layer material, a middle layer material and a surface layer material. The base layer material is an organosilicon material. The middle layer material is high-strength and high-durability fiberglass reinforced plastic. The surface layer material is a hydrophobic material. The anti-corrosion method includes: preparing fiberglass reinforced plastic; cleaning a surface of a submerged floating tunnel pipe section concrete material, preparing an organosilicon material, and coating the organosilicon material onto the surface of the pipe section concrete material; and preparing a hydrophobic material, and spray-coating the hydrophobic material onto a surface of the fiberglass reinforced plastic. The organosilicon material is adopted to improve the durability of the pipe section concrete and the bonding performance between the fiberglass reinforced plastic and the pipe section concrete.

### CROSS REFERENCE TO THE RELATED APPLICATIONS

This application is the national phase entry of International Application No. PCT/CN2022/115382, filed on Aug. 29, 2022, which is based upon and claims priority to Chinese Patent Application No. 202111568992.4, filed on Dec. 21, 2021, the entire contents of which are incorporated herein by reference.

### TECHNICAL FIELD

This application belongs to the technical field of anti-corrosion of concrete structures, and in particular relates to an anti-corrosion material and anti-corrosion method for submerged floating tunnel pipe section concrete.

### BACKGROUND

Due to the many technical problems that cannot be solved in the construction of bridges in deep sea areas, submerged floating tunnels, as a new type of transportation structure that spans deep sea areas such as straits and bays, can solve the technical difficulties in transportation construction in deep sea areas. Compared with immersed tube tunnels and deep buried underwater tunnels, there is greater flexibility in selecting the plane position and vertical depth of submerged floating tunnels, and they are not affected by seabed topography, hydrogeological conditions, etc. Therefore, submerged floating tunnels are receiving increasing attention. Due to the strong corrosive effect of seawater on reinforced concrete of submerged floating tunnel pipe sections, it is necessary to adopt high-durability and anti-corrosion materials for anti-corrosion treatment to protect materials of submerged floating tunnel pipe sections, so as to ensure that the submerged floating tunnel has a high-durability and anti-corrosion life of at least 120 years, thus ensuring the safe operation of the submerged floating tunnel. At the same time, the submerged floating tunnel pipe sections also face the scouring effect of ocean currents, tidal waves and the like, so that the requirements on the mechanical performance and wear resistance of the anti-corrosion layer are high. Therefore, it is necessary to develop an anti-corrosion method for submerged floating tunnel pipe section concrete.

In recent years, fiberglass reinforced plastic coating anti-corrosion technology has been increasingly applied in anti-corrosion treatment and repair in marine environments. However, fiberglass reinforced plastic anti-corrosion materials have technical problems such as poor bonding strength with the concrete base layer and insufficient durability life. In addition, due to the strong scouring effect of seawater flow on the seabed on the submerged floating tunnel, a large amount of underwater aquatic organisms will grow and accumulate on the surface of the submerged floating tunnel pipe section. Therefore, the technical problems such as seawater flow impact resistance of fiberglass reinforced plastic and attachment of aquatic organisms should also be solved.

### SUMMARY

Aiming at the shortcomings or deficiencies of the related art, the technical problem to be solved by this application is to provide an anti-corrosion material and anti-corrosion method for submerged floating tunnel pipe section concrete. In this application, an organosilicon material is adopted to improve the durability of the pipe section concrete and the bonding performance between the fiberglass reinforced plastic and the pipe section concrete; high-strength and high-durability fiberglass reinforced plastic is adopted to protect the pipe section from seawater scouring and corrosion; a hydrophobic material is adopted on the surface of the fiberglass reinforced plastic to slow down scouring of seawater flow and enrichment of aquatic organisms, thus improving the anti-corrosion performance of the submerged floating tunnel pipe section concrete.

In order to solve the technical problem, this application adopts the following technical solutions:

This application provides an anti-corrosion material for submerged floating tunnel pipe section concrete, including a base layer material, a middle layer material and a surface layer material, the base layer material being an organosilicon material, the middle layer material being high-strength and high-durability fiberglass reinforced plastic, and the surface layer material being a hydrophobic material.

Optionally, in the anti-corrosion material for submerged floating tunnel pipe section concrete, the organosilicon material is an alkylsilanol water-based organosilicon material, the mass ratio of an effective component of the organosilicon material to water is 1:0.5, and the penetration depth in concrete is not less than 2.5 mm; the water absorption rate is less than 0.001 mm/min^{1/2}, and the chloride absorption reducing effect is more than 96%.

Optionally, in the anti-corrosion material for submerged floating tunnel pipe section concrete, the fiberglass reinforced plastic adopts a plurality of layers of fiberglass fabric and a plurality of layers of gel coat. More preferably, in this application, at least five layers of fiberglass fabric and at least six layers of gel coat are adopted.

Optionally, in the anti-corrosion material for submerged floating tunnel pipe section concrete, the fiberglass fabric is an alkali-free fiberglass fabric with a thickness of 0.2-0.4 mm; and/or the gel coat is composed of a resin, an initiator, a promoter, an enhancer, and a defoamer, and the mass ratio of the resin to the initiator to the promoter to the enhancer to the defoamer is (50-60):(1.5-3.5):(0.3-2.0):(0.5-1.5):(0.001-0.005).

Optionally, in the anti-corrosion material for submerged floating tunnel pipe section concrete, the resin is epoxy vinyl ester resin; and/or
the initiator is methyl ethyl ketone peroxide; and/or
the promoter is cobalt isooctanoate; and/or
the enhancer is calcium carbonate with an average particle size of 30-50 nm; and/or
the defoamer is a polyether defoamer.

Optionally, in the anti-corrosion material for submerged floating tunnel pipe section concrete, the thickness of the fiberglass reinforced plastic is 3.0-4.0 mm.

Optionally, in the anti-corrosion material for submerged floating tunnel pipe section concrete, the 15 d bending strength of the fiberglass reinforced plastic is more than 250 MPa, the tensile strength of the fiberglass reinforced plastic is more than 120 MPa, and the 30 d water absorption rate of the fiberglass reinforced plastic is not more than 0.1%.

Optionally, in the anti-corrosion material for submerged floating tunnel pipe section concrete, the hydrophobic material adopts a composite nano-SiO₂ and nano-TiO₂ fluoropolymer, the coating thickness is 0.3-0.7 mm and the water contact angle of a coating is more than 150°.

In this application, the strength grade of the pipe section concrete is C40-C100.

In another aspect, this application provides an anti-corrosion method using the anti-corrosion material for submerged floating tunnel pipe section concrete, including:
preparing fiberglass reinforced plastic;
cleaning a surface of a submerged floating tunnel pipe section concrete material, preparing an organosilicon material, and coating the organosilicon material onto the surface of the pipe section concrete material; and
preparing a hydrophobic material, and spray-coating the hydrophobic material onto a surface of the fiberglass reinforced plastic.

Optionally, the anti-corrosion method includes: weighing the initiator, the enhancer and the defoamer according to the ratio, sequentially adding the initiator, the enhancer and the defoamer to the resin, performing uniform stirring, then adding the promoter while stirring, and obtaining the gel coat after uniform stirring; applying the uniformly stirred gel coat onto a forming surface of a mold and laying a fiberglass fabric; repeating the fiberglass fabric laying operation until a design thickness is reached, and then performing curing and demolding; and/or
cleaning harmful substances such as dust and oil on the surface of the submerged floating tunnel pipe section concrete material, preparing a water-based organosilicon material, coating the water-based organosilicon material onto the surface of the concrete, laying fiberglass reinforced plastic, and applying a certain force to firmly bond the fiberglass reinforced plastic with the pipe section concrete; and/or
preparing a composite nano-SiO₂ and nano-TiO₂ fluoropolymer hydrophobic material, and spray-coating the hydrophobic material onto the surface of the fiberglass reinforced plastic.

Compared with the related art, this application has the following technical effects:

Aiming at the technical problems such as poor bonding strength between the fiberglass reinforced plastic resin and the concrete base layer, which can easily lead to detachment, this application adopts the environment-friendly water-based organosilicon material to solve the technical problem of poor bonding strength between the conventional fiberglass reinforced plastic resin and the concrete, thus effectively improving the bonding between the fiberglass reinforced plastic and the pipe section concrete, and fully playing the protective role of the fiberglass reinforced plastic. The hydrophobic material has a good hydrophobic effect, thus reducing the impact of water flow on the submerged floating tunnel pipe section, avoiding the accumulation of marine organisms, and effectively protecting the pipe section concrete.

In this application, the water-based organosilicon material uses water as a solvent and contains no volatile organic solvent, thus avoiding the harm of the conventional oily organosilicon material to human body and the environment. The water-based organosilicon material can seep into the interior of the concrete and has a penetration depth of not less than 2.5 mm, thus effectively improving the durability of the concrete.

This application adopts nano calcium carbonate to fill the pores of the fiberglass reinforced plastic, and adopts the polyether defoamer to eliminate bubbles in the fiberglass reinforced plastic, thus significantly improving the strength and durability of the fiberglass reinforced plastic, so that it has good mechanical properties such as compressive strength and bending strength, can resist external impact on the submerged floating tunnel, protect the pipe section concrete, effectively improve the toughness and impact resistance of the submerged floating tunnel pipe section. Moreover, it has high durability, and high-strength and high-durability fiberglass reinforced plastic can be obtained.

This application adopts a combination of the water-based organosilicon material, the fiberglass reinforced plastic, and the hydrophobic material, which can effectively improve the durability of the submerged floating tunnel pipe section concrete and ensure a corrosion resistance life of no less than 120 years, where the water-based organosilicon material has a protection effect of no less than 30 years, the fiberglass reinforced plastic has a protection effect of no less than 80 years, and the hydrophobic material has a protection effect of no less than 10 years, thus overcoming the technical defect of insufficient durability in the conventional fiberglass reinforced plastic coating technology.

The water-based organosilicon material, the fiberglass reinforced plastic, and the hydrophobic material in this application have the technical characteristics such as good constructability, high strength, high impact resistance, and high durability, which can be used in fields such as high-durability and anti-corrosion of submerged floating tunnel pipe section materials, and have good economic and social benefits.

### DETAILED DESCRIPTION OF THE EMBODIMENTS

The technical solutions in the examples of this application will be described below clearly and completely. Apparently, the described examples are merely some rather than all of the examples of this application. All other examples obtained by those of ordinary skills in the art based on the examples of this application without contributing any inventive labor shall still fall within the scope of protection of this application.

### 1. Testing Methods Involved in Examples are as Follows:

(1) The bending strength of the fiberglass reinforced plastic was determined in accordance with the relevant provisions of the national standard Test Method for Bending Property of Fiber Reinforced Plastics (GB/T 1449-2005).
(2) The tensile strength of the fiberglass reinforced plastic was determined in accordance with the relevant provisions of the national standard Test Method for Tensile Property of Fiber Reinforced Plastics (GB/T 1447).
(3) The water absorption rate of the fiberglass reinforced plastic was determined in accordance with the relevant provisions of the national standard Test Method for Water Absorption Property of Fiber Reinforced Plastics (GB/T 1462).
(4) The normal tensile bonding strength between the fiberglass reinforced plastic and the concrete was determined in accordance with Appendix F of the national standard Code for Design of Strengthening Concrete Structure (GB/T 50367-2006).
(5) The penetration depth, water absorption rate, and chloride absorption reducing effect of the water-based organosilicon were determined in accordance with the relevant provisions of the Technical Specification for Corrosion Prevention of Concrete Structures in Harbor Engineering (JTJ275-2000).

### 2. Raw Materials in Examples

(1) MFE-2 epoxy vinyl ester resin;
(2) 189 unsaturated polyester resin;
(3) E44 epoxy resin;
(4) methyl ethyl ketone peroxide, used as initiator;
(5) cobalt isooctanoate, used as promoter;
(6) calcium carbonate with average particle size of 30 nm, used as enhancer;
(7) polyether defoamer, used as defoamer;
(8) EWR400 alkali-free fiberglass fabric, used as fiberglass fabric;
(9) composite nano-SiO₂ and nano-TiO₂ fluoropolymer, used as hydrophobic material, with coating thickness of 0.5 mm; and
(10) C60 concrete for normal tensile bonding strength between fiberglass reinforced plastic and concrete.

### 3 Properties of Fiberglass Reinforced Plastic

### 3.1 Mixing Ratios of Fiberglass Reinforced Plastic in Examples

For the mixing ratios of the fiberglass reinforced plastic, see Table 1.

TABLE 1
Mixing ratios of fiberglass reinforced plastic in Example 1 to Example 4

| Name of raw material | Example 1 (%) | Example 2 (%) | Example 3 (%) | Example 4 (%) |
|---|---|---|---|---|
| MFE-2 epoxy vinyl | 52 | 50 | 50 | 60 |
| ester resin | | | | |
| Initiator | 1.2 | 1.5 | 1.5 | 3.5 |
| Promoter | 1.0 | 0.3 | 0.8 | 2.0 |
| Enhancer | 0 | 0.5 | 0.9 | 1.5 |
| Defoamer | 0 | 0.001 | 0.002 | 0.005 |
| Fiberglass fabric | 48 | 48 | 48 | 58 |
| Hydrophobic material | 0 | 0 | 10.5 | 11.5 |

### 3.2 Property Test Results of Fiberglass Reinforced Plastic

For the property test results of the fiberglass reinforced plastic, see Table 2.

TABLE 2
Property test results and chloride ion penetration
resistance life of fiberglass reinforced plastic

| | Thickness of | | | | | Chloride ion |
|---|---|---|---|---|---|---|
| | fiberglass | | | Water | Chloride ion | penetration |
| | reinforced | Bending | Tensile | absorption | diffusion | resistance |
| | plastic | strength | strength | rate | coefficient | life |
| Examples | (mm) | (MPa) | (MPa) | (%) | (cm²/s) | (year) |
| Example 1 | 3.5 | 450 | 102 | 0.15 | 2.51*10⁻¹¹ | 61 |
| Example 2 | 3.5 | 560 | 125 | 0.05 | 0.74*10⁻¹¹ | 85 |
| Example 3 | 3.5 | 590 | 138 | 0.02 | 0.67*10⁻¹¹ | 93 |
| Example 4 | 3.5 | 620 | 145 | 0.01 | 0.61*10⁻¹¹ | 98 |

From the test results in Table 2 above, it can be seen that the bending strength and tensile strength of the fiberglass reinforced plastic added with nano calcium carbonate and defoamer in Example 2 are significantly higher than those in Example 1, the water absorption rate and chloride ion diffusion coefficient are significantly lower than those in Example 1, and the chloride ion penetration resistance life is more than 80 years. In addition, in a case that the surface of the fiberglass reinforced plastic adopts a hydrophobic material, the bending strength and tensile strength of Example 3 and Example 4 are further increased, the water absorption rate and chloride ion diffusion coefficient are further reduced, and the chloride ion penetration resistance life is more than 90 years.

### 4. Bonding Strength Between Fiberglass Reinforced Plastic and Concrete

The fiberglass reinforced plastic in Example 2 as shown in Table 1 was used, and MFE-2 epoxy vinyl ester resin, 189 unsaturated polyester resin, E44 epoxy resin and water-based organosilicon material were respectively used as bonding materials for the fiberglass reinforced plastic and the concrete to test the normal tensile bonding strength between the fiberglass reinforced plastic and the concrete. The test results are as shown in Table 3 below.

TABLE 3
Normal tensile bonding strength between fiberglass reinforced
plastic and concrete

| Serial number | | Normal tensile |
|---|---|---|
| of test | Type of bonding material | bonding strength (MPa) |
| 1 | MFE-2 epoxy vinyl ester resin | 3.5 |
| 2 | 189 unsaturated polyester resin | 3.9 |
| 3 | E44 epoxy resin | 4.5 |
| 4 | Water-based organosilicon material | 6.6 |

From Table 3 above, it can be seen that the normal tensile bonding strength between the fiberglass reinforced plastic and the concrete in a case that the water-based organosilicon material is used is significantly higher than that in a case that MFE-2 epoxy vinyl ester resin, 189 unsaturated polyester resin and E44 epoxy resin are used, which can effectively ensure the bonding between the fiberglass reinforced plastic and the pipe section concrete, and fully play the role of the fiberglass reinforced plastic.

### 5. Test Results of Water-Based Organosilicon

For the test results of the water-based organosilicon, see Table 4.

TABLE 4
Properties of water-based organosilicon material

| | Water | Chloride | Chloride ion |
|---|---|---|---|
| | absorption | absorption | penetration |
| Penetration | rate | reducing effect | resistance life |
| depth (mm) | (mm/min^{1/2}) | (%) | (year) |
| 3.0 | 0.0008 | 97 | 35 |

In this example, the used water-based organosilicon material has a penetration depth of 3.0 mm, a water absorption rate of 0.0008 mm/min^{1/2}, a chloride absorption reducing effect of up to 97%, and a chloride ion penetration resistance life of 35 years.

The main process of an anti-corrosion method for submerged floating tunnel pipe section in this example was as follows:

Firstly, a fiberglass reinforced plastic product was fabricated in a factory. An initiator, an enhancer and a defoamer were weighed according to the ratio and sequentially added to a resin for uniform stirring. Then, a promoter was added while stirring. After uniform stirring, a gel coat was obtained. A demolding agent was coated onto a forming surface of a cleaned or surface treated mold. After full drying, the uniformly stirred gel coat was coated onto the forming surface of the mold. Then, a cut fiberglass fabric is laid thereon, immersion in a resin was performed, and bubbles were removed. The above fiberglass fabric laying operation was repeated until a design thickness was reached. Then, curing and demolding were performed.

Then, harmful substances such as dust and oil on the surface of the submerged floating tunnel pipe section concrete material were cleaned. A water-based organosilicon material was prepared. The organosilicon material was coated onto the surface of the concrete. It was ensured that the pipe section concrete was fully immersed. 20-30 min later, the organosilicon material was coated for a second time, the fiberglass reinforced plastic material was laid immediately, and a certain force was applied to firmly bond the fiberglass reinforced plastic with the pipe section concrete.

Finally, a composite nano-SiO₂ and nano-TiO₂ fluoropolymer hydrophobic material was prepared, and the hydrophobic material was spray-coated onto the surface of the fiberglass reinforced plastic. The spray-coating thickness was preferably 0.3-0.7 mm.

This application adopts a composite anti-corrosion technology using a water-based organosilicon material, fiberglass reinforced plastic and a hydrophobic material, provides an anti-corrosion method that can achieve 120-year protection, and can effectively meet the needs of submerged floating tunnel pipe section materials.

The above examples are only intended to describe the technical solution of this application, rather than limit it. This application has been described in detail with reference to the preferred examples. Those of ordinary skills in the art should understand that modifications or equivalent replacements may be made to the technical solution of this application without departing from the spirit and scope of the technical solution of this application, which, however, should also be included within the scope of the claims of this application.

What is claimed is:

1. An anti-corrosion material for submerged floating tunnel pipe section concrete, comprising a base layer material, a middle layer material and a surface layer material, wherein the base layer material is an organosilicon material, the middle layer material is high-strength and high-durability fiberglass reinforced plastic, and the surface layer material is a hydrophobic material.

2. The anti-corrosion material for submerged floating tunnel pipe section concrete according to claim 1, wherein the organosilicon material is an alkylsilanol water-based organosilicon material, a mass ratio of an effective component of the organosilicon material to water is 1:0.5, and a penetration depth in concrete is greater than or equal to 2.5 mm; a water absorption rate is less than 0.001 mm/min^{1/2}, and a chloride absorption reducing effect is more than 96%.

3. The anti-corrosion material for submerged floating tunnel pipe section concrete according to claim 1, wherein the high-strength and high-durability fiberglass reinforced plastic adopts a plurality of layers of fiberglass fabric and a plurality of layers of gel coat.

4. The anti-corrosion material for submerged floating tunnel pipe section concrete according to claim 3, wherein the fiberglass fabric is an alkali-free fiberglass fabric with a thickness of 0.2 mm-0.4 mm; and/or
the gel coat comprises a resin, an initiator, a promoter, an enhancer, and a defoamer, and a mass ratio of the resin to the initiator to the promoter to the enhancer to the defoamer is (50-60):(1.5-3.5):(0.3-2.0):(0.5-1.5):(0.001-0.005).

5. The anti-corrosion material for submerged floating tunnel pipe section concrete according to claim 4, wherein the resin is epoxy vinyl ester resin; and/or
the initiator is methyl ethyl ketone peroxide; and/or
the promoter is cobalt isooctanoate; and/or
the enhancer is calcium carbonate with an average particle size of 30 nm-50 nm; and/or
the defoamer is a polyether defoamer.

6. The anti-corrosion material for submerged floating tunnel pipe section concrete according to claim 1, wherein a thickness of the high-strength and high-durability fiberglass reinforced plastic is 3.0 mm-4.0 mm.

7. The anti-corrosion material for submerged floating tunnel pipe section concrete according to claim 1, wherein a 15 d bending strength of the high-strength and high-durability fiberglass reinforced plastic is more than 250 MPa, a tensile strength of the high-strength and high-durability fiberglass reinforced plastic is more than 120 MPa, and a 30 d water absorption rate of the high-strength and high-durability fiberglass reinforced plastic is less than or equal to 0.1%.

8. The anti-corrosion material for submerged floating tunnel pipe section concrete according to claim 1, wherein the hydrophobic material adopts a composite nano-SiO₂ and nano-TiO₂ fluoropolymer, a coating thickness is 0.3-0.7 mm, and a water contact angle of a coating is more than 150°.

9. An anti-corrosion method using the anti-corrosion material for submerged floating tunnel pipe section concrete according to claim 1, comprising:
preparing the high-strength and high-durability fiberglass reinforced plastic;
cleaning a surface of the submerged floating tunnel pipe section concrete, preparing the organosilicon material, and coating the organosilicon material onto the surface of the submerged floating tunnel pipe section concrete; and
preparing the hydrophobic material, and spray-coating the hydrophobic material onto a surface of the high-strength and high-durability fiberglass reinforced plastic.

10. The anti-corrosion method according to claim 9, wherein in a process of preparing the high-strength and high-durability fiberglass reinforced plastic, the anti-corrosion method comprises: weighing an initiator, an enhancer and a defoamer according to a ratio, sequentially adding the initiator, the enhancer and the defoamer to a resin, performing uniform stirring, then adding a promoter while stirring, and obtaining a gel coat after uniform stirring; applying the gel coat onto a forming surface of a mold and laying a fiberglass fabric; repeating a fiberglass fabric laying operation until a design thickness is reached, and then performing curing and demolding; and/or
cleaning harmful substances comprising dust and oil on the surface of the submerged floating tunnel pipe section concrete, preparing a water-based organosilicon material, coating the water-based organosilicon material onto the surface of the submerged floating tunnel pipe section concrete, laying the high-strength and high-durability fiberglass reinforced plastic, and applying a certain force to firmly bond the high-strength and high-durability fiberglass reinforced plastic with the submerged floating tunnel pipe section concrete; and/or
preparing a composite nano-SiO₂ and nano-TiO₂ fluoropolymer hydrophobic material, and spray-coating the composite nano-SiO₂ and nano-TiO₂ fluoropolymer hydrophobic material onto the surface of the high-strength and high-durability fiberglass reinforced plastic.

11. The anti-corrosion material for submerged floating tunnel pipe section concrete according to claim 2, wherein a thickness of the high-strength and high-durability fiberglass reinforced plastic is 3.0 mm-4.0 mm.

12. The anti-corrosion material for submerged floating tunnel pipe section concrete according to claim 3, wherein a thickness of the high-strength and high-durability fiberglass reinforced plastic is 3.0 mm-4.0 mm.

13. The anti-corrosion material for submerged floating tunnel pipe section concrete according to claim 4, wherein a thickness of the high-strength and high-durability fiberglass reinforced plastic is 3.0 mm-4.0 mm.

14. The anti-corrosion material for submerged floating tunnel pipe section concrete according to claim 5, wherein a thickness of the high-strength and high-durability fiberglass reinforced plastic is 3.0 mm-4.0 mm.

15. The anti-corrosion material for submerged floating tunnel pipe section concrete according to claim 2, wherein a 15 d bending strength of the high-strength and high-durability fiberglass reinforced plastic is more than 250 MPa, a tensile strength of the high-strength and high-durability fiberglass reinforced plastic is more than 120 MPa, and a 30 d water absorption rate of the high-strength and high-durability fiberglass reinforced plastic is less than or equal to 0.1%.

16. The anti-corrosion material for submerged floating tunnel pipe section concrete according to claim 3, wherein a 15 d bending strength of the high-strength and high-durability fiberglass reinforced plastic is more than 250 MPa, a tensile strength of the high-strength and high-durability fiberglass reinforced plastic is more than 120 MPa, and a 30 d water absorption rate of the high-strength and high-durability fiberglass reinforced plastic is less than or equal to 0.1%.

17. The anti-corrosion material for submerged floating tunnel pipe section concrete according to claim 4, wherein a 15 d bending strength of the high-strength and high-durability fiberglass reinforced plastic is more than 250 MPa, a tensile strength of the high-strength and high-durability fiberglass reinforced plastic is more than 120 MPa, and a 30 d water absorption rate of the high-strength and high-durability fiberglass reinforced plastic is less than or equal to 0.1%.

18. The anti-corrosion material for submerged floating tunnel pipe section concrete according to claim 5, wherein a 15 d bending strength of the high-strength and high-durability fiberglass reinforced plastic is more than 250 MPa, a tensile strength of the high-strength and high-durability fiberglass reinforced plastic is more than 120 MPa, and a 30 d water absorption rate of the high-strength and high-durability fiberglass reinforced plastic is less than or equal to 0.1%.

19. The anti-corrosion method according to claim 9, wherein in the anti-corrosion material for submerged floating tunnel pipe section concrete, the organosilicon material is an alkylsilanol water-based organosilicon material, a mass ratio of an effective component of the organosilicon material to water is 1:0.5, and a penetration depth in concrete is greater than or equal to 2.5 mm; a water absorption rate is less than 0.001 mm/min^{1/2}, and a chloride absorption reducing effect is more than 96%.

20. The anti-corrosion method according to claim 9, wherein in the anti-corrosion material for submerged floating tunnel pipe section concrete, the high-strength and high-durability fiberglass reinforced plastic adopts a plurality of layers of fiberglass fabric and a plurality of layers of gel coat.
